(19) United States
(12) Patent Application Publication
(10) Pub. No.: US 2025/0355295 A1
(43) Pub. Date: Nov. 20, 2025

(54) OPTICAL MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Hiroshi ANDO, Nisshin-shi (JP); Kojiro TACHI, Nisshin-shi (JP); Masaaki KAWAUCHI, Nisshin-shi (JP); Masatoshi TSUJI, Nisshin-shi (JP); Heng LIU, Nisshin-shi (JP)

(21) Appl. No.: 19/175,553

(22) Filed: Apr. 10, 2025

(30) Foreign Application Priority Data
May 17, 2024 (JP) 2024-080885

(51) Int. Cl. G02F 1/1335; G02F 1/13; G02F 1/137

(52) U.S. Cl. CPC G02F 1/133553; G02F 1/1323; G02F 1/133524; G02F 1/13718; G02F 2201/38

(57) ABSTRACT

An optical member includes a mirror that reflects light and a switching mirror that is switchable between a transparent state in which light is transmitted and a reflective state in which light is reflected. The switching mirror is disposed in parallel with the mirror. The switching mirror is configured to reflect an incident light having an incident angle of θ at a reflection angle of φ larger than θ in the reflective state. The mirror is configured to reflect an incident light having an incident angle of φ at a reflection angle of θ.

### CROSS REFERENCE TO RELATED APPLICATION

The present application claims the benefit of priority from Japanese Patent Application No. 2024-080885 filed on May 17, 2024. The entire disclosure of the above application is incorporated herein by reference.

### TECHNICAL FIELD

The present disclosure relates to an optical member.

### BACKGROUND

Conventionally, optical members that include components functioning as a pair of mirrors and are capable of guiding and outputting incident light have been known.

### SUMMARY

An optical member according to an example of the present disclosure includes a mirror that reflects light and a switching mirror that is switchable between a transparent state in which light is transmitted and a reflective state in which light is reflected. The switching mirror is disposed in parallel with the mirror. The switching mirror is configured to reflect an incident light having an incident angle of θ at a reflection angle of φ larger than θ in the reflective state. The mirror is configured to reflect an incident light having an incident angle of φ at a reflection angle of θ.

### BRIEF DESCRIPTION OF DRAWINGS

Objects, features and advantages of the present disclosure will become apparent from the following detailed description made with reference to the accompanying drawings. In the drawings:

FIG. 1 is a cross-sectional view illustrating an optical member according to a first embodiment;

FIG. 2 is an enlarged cross-sectional view of a region II of a mirror in FIG. 1;

FIG. 3 is a diagram illustrating an example of partitioned regions of a switching mirror and a circuit board for controlling the partitioned regions;

FIG. 4 is an enlarged view of a region IV of FIG. 1, and is an enlarged cross-sectional view of the switching mirror in a reflective state;

FIG. 5 is a view corresponding to FIG. 4, and is an enlarged cross-sectional view of the switching mirror in a transparent state;

FIG. 6 is an explanatory diagram of a case where a first region of the switching mirror is in the transparent state;

FIG. 7 is an explanatory diagram of a case where a second region of the switching mirror is in the transparent state;

FIG. 8 is an explanatory diagram of a case where an N-th region of the switching mirror is in the transparent state;

FIG. 9 is an explanatory diagram of a width of each region of the switching mirror and a direct incidence region;

FIG. 10 is an explanatory diagram of light guiding and thickness of an optical member of a comparative example;

FIG. 11 is an explanatory diagram of a thinning effect in the optical member according to the first embodiment;

FIG. 12 is a cross-sectional view illustrating an optical member according to a second embodiment;

FIG. 13 is an explanatory diagram of light guiding when one region of a switching mirror is in the transparent state in the optical member of the second embodiment;

FIG. 14 is an explanatory diagram of light guiding in a terminal region in an optical member according to the second embodiment;

FIG. 15 is a cross-sectional view illustrating an optical member according to a third embodiment;

FIG. 16 is an explanatory diagram of light guiding in the optical member according to the third embodiment;

FIG. 17 is an enlarged cross-sectional view of a region XVII of FIG. 16, and is an enlarged cross-sectional view of a mirror according to a modified example; and

FIG. 18 is an enlarged cross-sectional view of a region XVIII of FIG. 16, and is an enlarged cross-sectional view of a switching mirror according to a modified example.

### DETAILED DESCRIPTION

Next, a relevant technology is described only for understanding the following embodiments. An optical member has a pair of mirrors arranged to face each other, in which one of the pair of mirrors mainly reflects light and the other is a half mirror that reflects and transmits light. When an external light enters between the pair of mirrors, the external light is reflected and outputted between the pair of mirrors. This optical member can be used, for example, as a blind spot assistance device. In a case where the half mirror is composed of a vapor-deposited metal film, a light absorption rate is 30% or more and thus a light intensity is decreased. On the other hand, in a case where the half mirror is composed of a dielectric multilayer film, a light absorption rate is low and thus a light loss can be reduced, but a reflectance changes depending on a wavelength and an incident angle of light.

In view of the above issues, it is conceivable to use a half-mirrorless optical member to restrict a decrease in light intensity and changes in brightness and color of an outside view visually perceived by a user. In the half-mirrorless optical member, an exit surface from which light exits toward the user may include a plurality of flat portions that function as mirrors by total reflection, and a plurality of prism portions from which light exits.

As the half-mirrorless optical member, a switching mirror switchable between a transmitting state and a reflective state can also be used.

In recent years, there has been a need for thinner designs in the field of this type of optical members. Each of the optical members described above has a structure in which incident light is specularly reflected at a portion that guides the incident light inside, so that an angle of incidence and an angle of reflection are equal. Here, a distance between components functioning as a pair of mirrors, that is, a thickness, is T, the angle of incidence and the angle of reflection of incident light are θ, and a distance that light travels when making one round trip between the components, that is, a width, is W. At this time, since the thickness T of the optical member is determined by a relationship T=W/2 tan θ, it is difficult to make the optical member thinner.

On the other hand, in the optical member in which the exit surface includes the plurality of flat portions and the plurality of prism portions can be made thinner than other optical members by inclining an incident surface that allows external light to enter the inside and increasing the angle of incidence, but the light exits toward the user in a pattern by the plurality of prism portions. Therefore, this optical member may reduce the visibility of the outside view in the blind spot.

An optical member according to an aspect of the present disclosure includes a mirror having a first reflective layer that reflects light, and a switching mirror disposed in parallel with the mirror and having a second reflective layer that is switchable between a transparent state in which light is transmitted and a reflective state in which light is reflected. A normal direction to a plane of the mirror or a plane of the switching mirror is defined as a thickness direction, an angle between a traveling direction of an incident light that is incident on the mirror or the switching mirror and the thickness direction is defined as an incident angle, and an angle between a traveling direction of a reflected light that is reflected by the mirror or the switching mirror and the thickness direction is defined as a reflection angle. The first reflective layer has a first inclined plane that is inclined with respect to the plane of the mirror, and an axis along a normal direction to the first inclined plane is a first inclination axis. The second reflective layer has a second inclined plane that is inclined with respect to the plane of the switching mirror, and an axis along a normal direction to the second inclined plane is a second inclination axis. The switching mirror is configured to reflect the incident light having the incident angle of θ at the reflection angle of φ that is larger than θ. The mirror is configured such that the first inclination axis is parallel to the second inclination axis so as to reflect the incident light having the incident angle of φ at the reflection angle of θ.

This optical member includes the mirror and the switching mirror arranged in parallel. The mirror has the first reflective layer that reflects light. The switching mirror has the second reflective layer that is switchable between the transparent state in which light is transmitted and the reflective state in which light is reflected. Furthermore, when the incident angle of incident light is θ, the switching mirror in the reflective state reflects the incident light at the angle φ larger than θ. The mirror reflects the incident light having the incident angle φ at the angle θ because the first inclination axis of the first reflective layer is parallel to the second inclination axis of the second reflective layer. In this optical member, the switching mirror that outputs light toward the user does not have protruding prisms, so that the external light does not exit in a pattern that follows the arrangement of the prisms, thereby suppressing a decrease in visibility of the outside view visually perceived by the user. In addition, this optical member is configured such that the angles of incident light and reflected light at the mirror and switching mirror are different, so that the distance that light travels when making one round trip between the mirror and the switching mirror is increased compared to when light is reflected specularly. Therefore, this optical member can be made thinner by shortening the distance between the mirror and the switching mirror in accordance with the increase in the distance that light travels when making one round trip between the mirror and the switching mirror.

The following describes embodiments of the present disclosure with reference to the drawings. In the following embodiments, the same or equivalent parts are denoted by the same reference numerals.

### First Embodiment

An optical member 1 according to a first embodiment of the present disclosure will be described with reference to the drawings. The optical member 1 of the present embodiment can be used, for example, as a blind spot assistance device that is attached to a member, an obstacle, or the like that blocks a field of view of a user and causes a blind spot, and makes an outside view in the blind spot visible to the user. For example, in a case where the optical member 1 is applied for a vehicle, the optical member 1 is attached to a pillar or the like of the vehicle, and directs external light from a blind spot due to the pillar toward a user so as to allow the user to visually perceive the outside view in the blind spot.

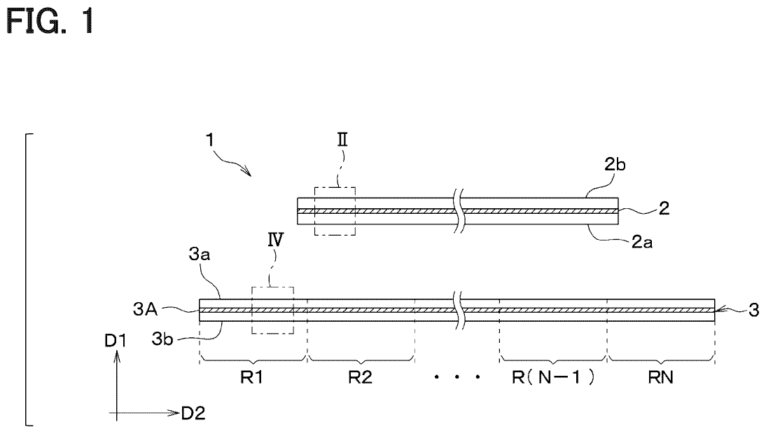

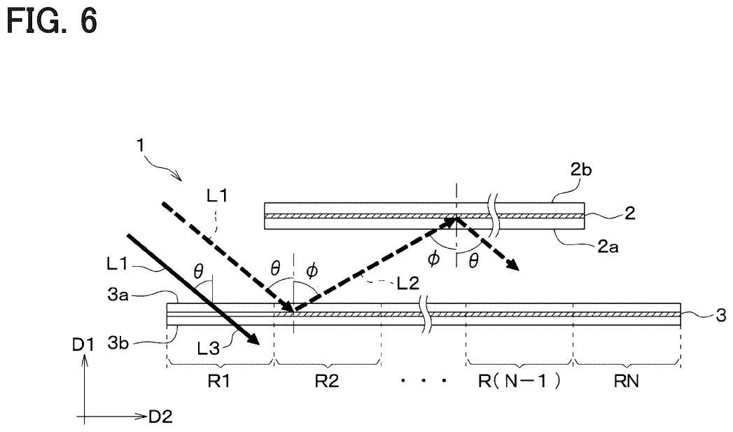

FIG. 1 corresponds to a cross-sectional view of the optical member 1 taken along line I-I of FIG. 1. In FIGS. 6 to 9, in order to make it easier to understand whether a plurality of regions R1 to RN of a switching mirror 3, which will be described later, are in a transparent state or a reflective state, regions in the reflective state are hatched and regions in the transparent state are shown in white. FIGS. 6 to 9 and 11 are cross-sectional views corresponding to FIG. 1.

As shown in FIG. 1, the optical member 1 includes, for example, a mirror 2 that reflects light, and the switching mirror 3 that is disposed parallel with and opposite the mirror 2 and is switchable between the transparent state in which light is transmitted and the reflective state in which light is reflected. In the optical member 1, the mirror 2 and the switching mirror 3 are attached to a housing or a holding member (not shown), and these two mirrors are held in a parallel state. The optical member 1 is configured such that when light enters from the rear side of the mirror 2 towards the switching mirror 3, a portion of the light repeatedly reflects off the regions of the switching mirror 3 in the reflective state and the mirror 2, while another portion of the light exits from the region of the switching mirror 3 in the transparent state. As a result, the optical member 1 guides the light, which is incident from a blind spot blocked by an obstacle (not shown), between the mirror 2 and the switching mirror 3, and then outputs the light to the outside over a wide range of the switching mirror 3, so as to allow the user to visually perceive the outside view in the blind spot.

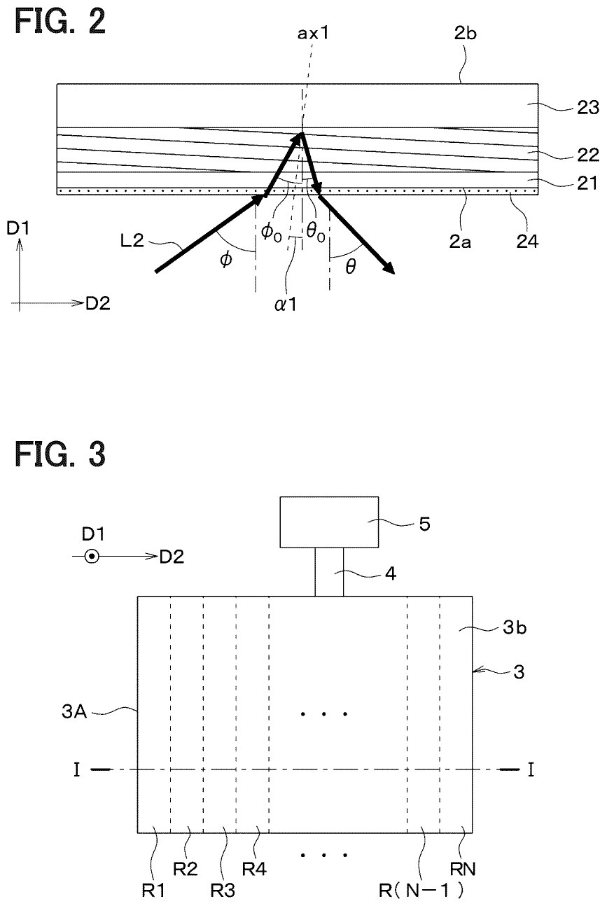

For ease of explanation, the normal direction to one surface 2a of the mirror 2 and a facing surface 3a of the switching mirror 3 that face each other, as shown by the arrow in FIG. 1, that is, a direction corresponding to a thickness direction of the optical member 1, will be referred to as a “thickness direction D1”. Moreover, a state in which the optical member 1 or its components are viewed from a direction along the thickness direction D1 is referred to as a “top view”. In addition, a direction along a plane formed by the facing surface 3a of the switching mirror 3, which is z direction from an end portion of the switching mirror 3 that protrudes from the mirror 2 when viewed from above (for example, an incident end portion 3A described later) toward an opposite end portion, is referred to as a “light guiding direction D2”. The light guiding direction D2 can be said to be a direction along which the light is guided by the mirror 2 and the switching mirror 3. The thickness direction D1 and the light guiding direction D2 indicated by arrows in FIG. 2 and subsequent figures correspond to the directions indicated by arrows in FIG. 1. For ease of explanation, a plane formed by the thickness direction D1 and the light guiding direction D2 shown in FIG. 1 and the like may be referred to as a “light guiding plane”.

As shown in FIG. 6, a light that is incident on the optical member 1 from the outside is referred to as an “external light L1”, and a light that is reflected by the switching mirror 3 from the external light L1 is referred to as an “incident light L2”. Furthermore, a light from the external light L1 that exits from an exit surface 3b of the switching mirror 3 through the optical member 1 is referred to as an “exit light L3”. In addition, in the light guiding plane, an angle between a traveling direction of light incident on the mirror 2 and the thickness direction D1, and an angle between a traveling direction of light incident on the switching mirror 3 and the thickness direction D1 are referred to as an “incident angle”. The light incident on the mirror 2 is the light reflected by the switching mirror 3 in the reflective state. The light incident on the switching mirror 3 is the external light L1 and the incident light L2 reflected by the mirror 2. In addition, in the light guiding plane, an angle between the traveling direction of the light reflected by mirror 2 and thickness direction D1, and an angle between the traveling direction of the light reflected by the switching mirror 3 and thickness direction D1 are referred to as a “reflection angle”. Furthermore, the incident angle and the reflection angle at the switching mirror 3 may be referred to as the “first incident angle” and the “first reflection angle”, and the incident angle and the reflection angle at the mirror 2 may be referred to as the “second incident angle” and the “second reflection angle”, respectively.

The mirror 2 is a reflective member that reflects visible light toward the switching mirror 3 with a reflectance equal to or higher than a predetermined value (for example, but not limited to, 80% or higher). The mirror 2 is paired with the switching mirror 3, and in order to make the optical member 1 thinner, the mirror 2 is designed to perform asymmetric reflection in which the incident light L2 is reflected at the second reflection angle different from the second incident angle. As shown in FIG. 2, the mirror 2 includes a transparent substrate 21, a first reflective layer 22, a light-shielding substrate 23 at least a part of which is made of a light-shielding material, and an anti-reflection layer 24. The mirror 2 has a configuration in which, for example, the light-shielding substrate 23, the first reflective layer 22, the transparent substrate 21, and the anti-reflection layer 24 are laminated in this order. The incident light L2 is incident on the mirror 2 from the one surface 2a facing the switching mirror 3 at an incident angle φ, and the incident light L2 is reflected by the first reflective layer 22 at a reflection angle θ (<φ).

The transparent substrate 21 is made of any light-transmitting material, such as glass or resin, and functions as a cover for the first reflective layer 22. The transparent substrate 21 has the anti-reflection layer 24 disposed on the one surface 2a facing the switching mirror 3.

The first reflective layer 22 performs asymmetric reflection by reflecting the incident light L2 at the second reflection angle θ that is different from the second incident angle φ and is the same as the first incident angle of the external light L1 incident on the switching mirror 3. As shown in FIG. 2, the first reflective layer 22 has a periodic layer structure in which liquid crystal layers aligned so as to be inclined at a certain angle α with respect to a plane of the one surface 2a are repeatedly laminated. The first reflective layer 22 is made of, for example, a cholesteric liquid crystal. In the mirror 2, for example, when the average refractive index of the transparent substrate 21 and the first reflective layer 22 is n (n>1), the second incident angle φ of the incident light L2 changes to φ₀ (φ₀<φ) due to internal refraction. The mirror 2 has a structure in which, for example, the first reflective layer 22 has a refractive index modulation of Δn in the above-described periodic layer structure, and light with the incident angle φ₀ is Bragg-reflected on an inclined plane with an inclination angle α inside the first reflective layer 22. In this case, sin φ/n=sin φ₀. Then, in the mirror 2, for example, the incident light L2 that is Bragg-reflected at the first reflective layer 22 has an internal reflection angle θ₀=φ₀-2α at the mirror 2, and the angle at which the light exits toward the switching mirror 3, that is, an external reflection angle, returns to the same θ as the incident angle of the external light L1 to the switching mirror 3. In this case, n×sin(φ₀−2α)=n×sin θ₀=sin θ. In other words, the mirror 2 serves to return the angle of the incident light L2 that has been asymmetrically reflected by the switching mirror 3 back to the angle before it was reflected by the switching mirror 3. As a result, when the incident light L2 reflected by the switching mirror 3 finally exits to the outside from the exit surface 3b, the optical member 1 returns to the same incident angle θ as the external light L1, ensuring continuity between the outside view visually perceived directly by the user and the outside view visually perceived through the optical member 1.

Here, for example, as shown in FIG. 2, a virtual line passing through the center of the incident light L2 and its reflected light on the inclined plane with the inclination angle α is defined as an inclination axis ax1, and an angle between the inclination axis ax1 and the thickness direction D1, that is, the inclination angle of the layer structure, is defined as α1. The inclination axis ax1 can also be said to be an axis along the normal direction to the inclined plane of the first reflective layer 22. At this time, the inclination angle α1 of the first reflective layer 22 is the same as an inclination angle α2 of the switching mirror 3 described later.

The light-shielding substrate 23 is made of, for example, any black material that absorbs visible light, and is configured so that external light L1 from an opposite surface 2b, which is a surface opposite to the one surface 2a, does not pass through the mirror 2. The light-shielding substrate 23 may be configured to block external light L1 entering from the opposite surface 2b, and may be configured in such a way that a light-shielding film made of any black material or the like is formed on a transparent substrate such as glass or a resin material, or in such a way that a separate light-shielding member is attached to a transparent substrate.

The anti-reflection layer 24 is formed on the one surface 2a of the mirror 2 facing the switching mirror 3, that is, on the surface of the transparent substrate 21, and serves to prevent the incident light L2 from being reflected on the one surface 2a, thereby reducing noise caused by surface reflection. The anti-reflection layer 24 may be, for example, an anti-reflection film, or may have a moth-eye structure formed directly on the transparent substrate 21.

The switching mirror 3 is a light adjustment member that has a plurality of partitioned regions R1 to RN (where N is a natural number greater than or equal to 2), as shown in FIG. 3. The switching mirror 3 is switchable between the transparent state in which visible light is transmitted and the reflective state in which visible light is reflected for each of the plurality of regions R1 to RN. The switching mirror 3 may also be called a “light adjustment mirror”. The plurality of regions R1 to RN can be called partitioned regions, and the number of the partitioned regions can be changed as appropriate.

For ease of explanation, in the following, as shown in FIG. 3, when viewed from above, one of two end portions of the switching mirror 3 that protrude from the mirror 2 will be referred to as the “incident end portion 3A”, the other will be referred to as a “terminal end portion”, and a side formed by the incident end portion 3A will be referred to as an “end side”. Furthermore, the number of the plurality of regions is N (where N is a natural number greater than or equal to 2), and the plurality of regions are referred to as a first region R1, a second region R2, a third region R3, a fourth region R4, . . . , an (N−1)th region R(N−1), and an Nth region RN, in that order from the incident end portion 3A toward the terminal end portion. It should be noted that dashed lines in FIG. 3 indicate boundaries between the regions R1 to RN of the switching mirror 3 merely for the sake of convenience and are not actually visible to the user.

The switching mirror 3 is partitioned, for example, into the plurality of regions R1 to RN arranged parallel to the end side. In FIG. 3, when viewed from above, the switching mirror 3 is rectangular and each of the plurality of regions R1 to RN is rectangular, but outer contours of the switching mirror 3 and each of the plurality of regions R1 to RN are not limited to these examples. For example, the switching mirror 3 and each of the plurality of regions R1 to RN may be parallelograms, and the outer contours may be changed as appropriate.

The switching mirror 3 has transparent electrodes 32 and 34 in the plurality of regions R1 to RN, and the transparent electrodes 32 to 34 are connected to a circuit board 5 for drive control through a wiring 4 such as a flexible printed circuit (FPC). Accordingly, it is possible to switch the transparent state and the reflective state in each of the plurality of regions R1 to RN in the switching mirror 3. The circuit board 5 is, for example, an electronic control unit having a CPU, a ROM, a RAM, and I/O, and the like (not shown) mounted on a board having circuit wiring (not shown). CPU, ROM, RAM, and I/O are abbreviations for Central Processing Unit, Read Only Memory, Random Access Memory, and Input/Output, respectively. The circuit board 5 is connected to, for example, a power source (not shown) and is disposed on the opposite surface 2b of the mirror 2. The circuit board 5 reads and executes a program for driving and controlling the switching mirror 3 that is stored in advance in a recording medium (not shown), for example, and performs light adjustment control of the switching mirror 3.

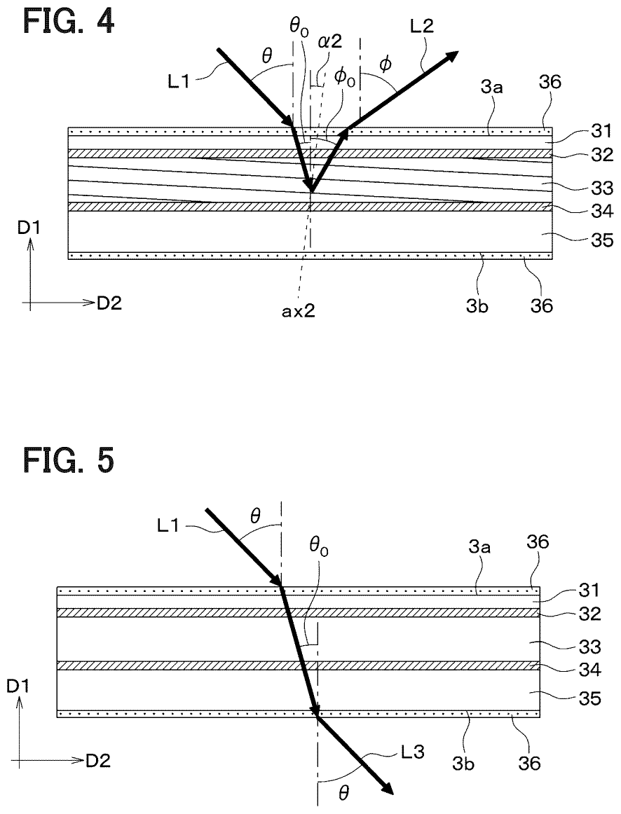

As shown in FIG. 4, for example, the switching mirror 3 includes a first transparent substrate 31, a first transparent electrode 32, a second reflective layer 33, a second transparent electrode 34, a second transparent substrate 35, and an anti-reflection layer 36. The switching mirror 3 is formed, for example, by laminating the first transparent substrate 31, the first transparent electrode 32, the second reflective layer 33, the second transparent electrode 34, and the second transparent substrate 35 in this order, and the anti-reflection layer 36 is formed on the facing surface 3a that faces the mirror 2 and on the exit surface 3b that is opposite to the facing surface 3a.

The first transparent substrate 31 and the second transparent substrate 35 are made of any light-transmitting material, such as glass or resin. The first transparent substrate 31 corresponds to a cover for the second reflective layer 33, and the first transparent electrode 32 is formed on a surface of the first transparent substrate 31 opposite to the facing surface 3a that faces the mirror 2. The second transparent substrate 35 corresponds to a base substrate of the second reflective layer 33, and the second transparent electrode 34 is formed on a surface of the second transparent substrate 35 that faces the first transparent substrate 31. The anti-reflection layer 36 is formed on the facing surface 3a of the first transparent substrate 31 and on the exit surface 3b of the second transparent substrate 35. The anti-reflection layer 36 may be, for example, an anti-reflection film or a moth-eye structure formed directly on the transparent substrates 31 and 35. The anti-reflection layer 36 prevents reflection on the surfaces of the transparent substrates 31 and 35, thereby suppressing noise caused by surface reflected light.

The first transparent electrode 32 and the second transparent electrode 34 are made of any conductive material having light-transmitting properties, such as indium tin oxide (ITO), and are electrodes that transmit visible light. For example, one or both of the first transparent electrode 32 and the second transparent electrode 34 are formed into a predetermined pattern shape partitioned into the plurality of regions R1 to RN, and configured to enable individual voltage application to the regions R1 to RN.

The second reflective layer 33 is made of, for example, cholesteric liquid crystal, similar to the first reflective layer 22, and is in the transparent state when a voltage is applied by the transparent electrodes 32, 34, and is in the reflective state otherwise. For example, in the reflective state, the second reflective layer 33 reflects visible light at a predetermined reflectance or higher (for example, but not limited to, 80% or higher) and does not transmit light. As shown in FIG. 4, for example, in the reflective state, the second reflective layer 33 is designed to perform asymmetric reflection by reflecting the external light L1 or the incident light L2 toward the mirror 2 at the first reflection angle of φ (>θ) that is different from the first incident angle of θ. Specifically, the second reflective layer 33, like the first reflective layer 22, is formed by repeatedly laminating liquid crystal layers oriented so as to be inclined at a certain angle α with respect to a plane formed by the facing surface 3a, forming a periodic layer structure with a predetermined refractive index modulation. In the switching mirror 3, for example, when an average refractive index of the first transparent substrate 31 and the second reflective layer 33 is n, the incident angle θ of the incident light L2 changes to θ₀ due to internal refraction, and the light with the incident angle θ₀ is Bragg-reflected on an inclined plane with the inclination angle α inside the second reflective layer 33. In this case, sin θ/n=sin θ₀ holds true. In the switching mirror 3, the incident light L2 that is Bragg-reflected at the second reflective layer 33 has an internal reflection angle of φ₀=θ₀+2α at the switching mirror 3, and an external reflection angle when exiting toward the mirror 2 becomes a first reflection angle φ that is larger than the first incident angle θ. In this case, n×sin(θ₀+2α)=n×sin φ₀=sin φ holds true.

As shown in FIG. 4, a virtual straight line passing through the center of the incident light L2 and its reflected light on the inclined plane of the second reflective layer 33 with the inclination angle α is defined as an inclination axis ax2, and an angle between the inclination axis ax2 and the thickness direction D1, that is, an inclination angle, is defined as α2. The inclination axis ax2 can also be said to be an axis along the normal direction to the inclined plane of the second reflective layer 33. The second reflective layer 33 has the inclination angle α2 that is equal to the inclination angle α1, and the inclination axis ax2 that is parallel to the inclination axis ax1. As a result, in the optical member 1, the first incident angle on the switching mirror 3 and the second reflection angle on the mirror 2 are the same θ, and the first reflection angle on the switching mirror 3 and the second incident angle on the mirror 2 are the same φ. For this reason, the optical member 1 is structured so that the incident light L2, whose angle has changed due to reflection at the switching mirror 3, returns to the original incident angle at the switching mirror 3 due to asymmetric reflection at the mirror 2, thereby ensuring continuity between the outside view in the blind spot visually perceived by the user and the outside view visually perceived directly by the user.

As shown in FIG. 5, for example, in the transparent state, the second reflective layer 33 is controlled by applying a voltage so that the arrangement of the liquid crystal material changes, the refractive index becomes uniform within the layer, and the inclined plane described above does not exist. “The refractive index becomes uniform within the layer” means that the refractive index is uniform in each direction, for example, the thickness direction D1, the light guiding direction D2, and the direction perpendicular to the light guiding plane formed by these directions. Therefore, in the transparent state, the second reflective layer 33 transmits the external light L1 that is incident or the incident light L2 reflected by the mirror 2. In the transparent region of the switching mirror 3, the external light L1 with the incident angle θ or the incident light L2 reflected by the mirror 2 is refracted internally and passes through the second reflective layer 33, and is refracted again when exiting from the exit surface 3b, and exits as the exit light L3 having an angle of θ.

During the light adjustment control, a voltage is applied to at least one of the regions R1 to RN of the switching mirror 3, and the region to which the voltage is applied becomes the transparent state to mainly transmit visible light. Specifically, the switching mirror 3 is controlled by the light adjustment control so that at least one of the regions from the first region R1 to the Nth region RN is in the transparent state, while all the remaining regions are in the reflective state, and the region in the transparent state is sequentially switched.

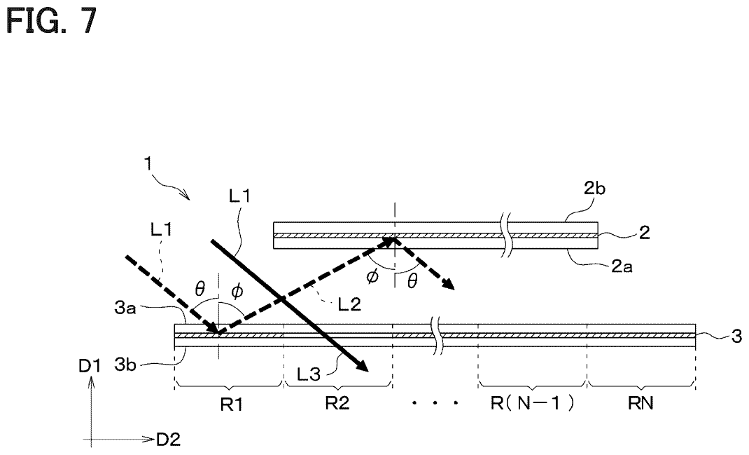

For example, as shown in FIG. 6, at a certain point in time, the first region R1 of the switching mirror 3 is brought into the transparent state by application of voltage, and the remaining regions are brought into the reflective state. The external light L1 that is incident on the first region R1 at this point in time passes through the first region R1 and exits as the exit light L3. On the other hand, the external light L1 incident on the other regions is reflected toward the mirror 2, and then is repeatedly reflected by the mirror 2 and the switching mirror 3, and is guided in a direction different from the external light L1 that reached the first region R1. In FIG. 6, for ease of viewing, the external light L1 incident on the transparent region of the switching mirror 3 is shown by a solid line, and the external light L1 incident on the reflective region and its reflected light are shown by dashed lines. The same applies to FIG. 7.

Additionally, as shown in FIG. 7, at another point in time, the second region R2 of the switching mirror 3 is switched from the reflective state to the transparent state by application of voltage, while the remaining regions are brought into the reflective state. In other words, when the first region R1 of the switching mirror 3 is switched from the transparent state to the reflective state, the second region R2 is switched from the reflective state to the transparent state, and the other regions R3 to RN are maintained in the reflective state. At this time, the external light L1 that reaches the second region R2 in the transparent state exits from the second region R2 as the exit light L3, and the external light L1 that reaches the other regions in the reflective state is guided without exiting from the switching mirror 3.

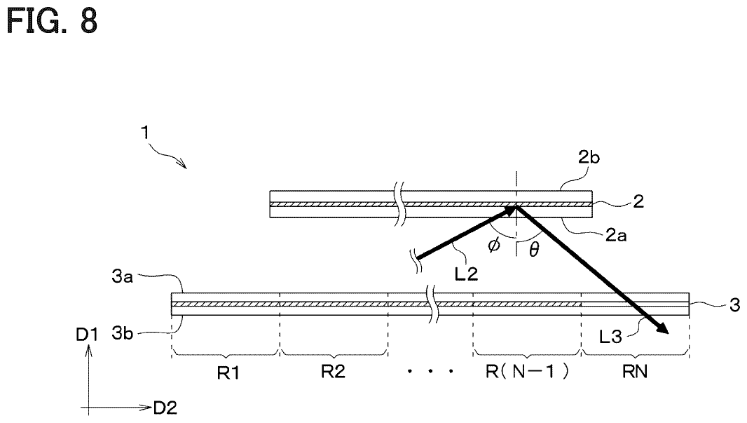

In the switching mirror 3, one region that is brought into the transparent state is sequentially switched. At another point in time, for example, as shown in FIG. 8, the Nth region RN is brought into the transparent state by application of voltage, and the remaining regions are brought into the reflective state. At this point in time, the external light L1 is guided by the switching mirror 3 and the mirror 2, and the incident light L2 that reaches the Nth region RN in the transparent state exits as it is as the exit light L3, and the light that does not reach the Nth region RN is guided in another direction. Note that, in FIGS. 6 to 8, for ease of viewing, the refraction of the external light L1 or the incident light L2 inside the mirror 2 or the switching mirror 3 is omitted for simplification. The same applies to the subsequent drawings.

In this manner, the light adjustment control of the switching mirror 3 is performed such that at least one of the plurality of regions R1 to RN is brought into the transparent state and all the other regions are brought into the reflective state, and the region in the transparent state is changed sequentially. As a result, external light L1 incident between the mirror 2 and the switching mirror 3 is reflected with high reflectance by the reflective region of the switching mirror 3 and exits with high transmittance from the transparent region. In addition, since the transparent region in the switching mirror 3 is switched sequentially, the switching mirror 3 can make the external light L1 or the incident light L2 exit as the exit light L3 over a wide range, allowing the user to visually perceive the outside view in the blind spot.

The region of the switching mirror 3 where the external light L1 directly enters, that is, the region from the incident end portion 3A to a predetermined position where the external light L1 enters, is referred to as a “direct incidence region”. As shown in FIG. 6, in a case where the switching mirror 3 has the first region R1 and the second region R2 in the direct incidence region, in the light adjustment control, the optical member 1 may be in the transparent state for the number of regions included in the direct incidence region and all the remaining regions may be in the reflective state. In this way, in the light adjustment control, the optical member 1 may set the number of regions brought into the transparent state at a certain point in time to one or more depending on the number of regions of the switching mirror 3 that are included in the direct incidence region.

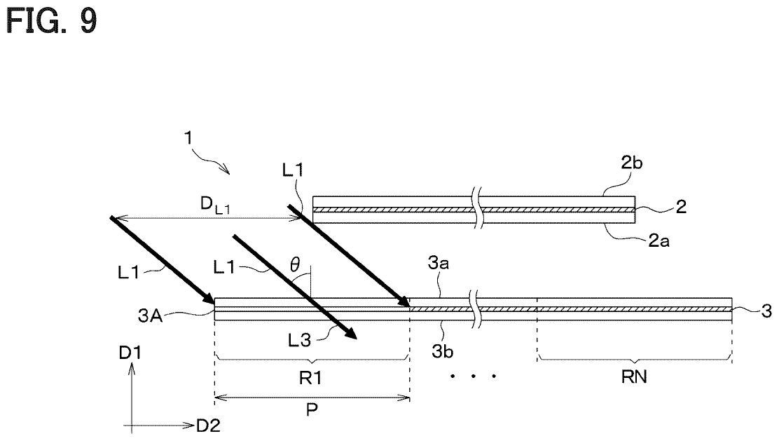

For example, as shown in FIG. 9, when a width of the direct incidence region in the light guiding direction D2 is D_{L1}, and a width of each of the plurality of regions R1 to RN in the light guiding direction D2 is P, the optical member 1 may be configured such that the width P is equal to the width D_{L1}. In other words, in the optical member 1, the width P of each region of the switching mirror 3 and the number of regions may be determined according to the width D_{L1} of the direct incidence region. When D_{L1}=P, in the light adjustment control, the optical member 1 sets only one of the plurality of regions R1 to RN in the transparent state and sets all the other regions in the reflective state, and sequentially switches the region in the transparent state. On the other hand, as described above, when D_{L1}>P, and the direct incidence region includes k regions (where k is an integer greater than or equal to 2), the light adjustment control can be performed by simultaneously setting k regions, where D_{L1}≈k×P, to the transparent state and setting all the remaining regions to the reflective state. By such light adjustment control, at a certain point in time, one or more regions located in the direct incidence region are simultaneously brought into the transparent state or the reflective state, thereby improving the efficiency of light guiding at the mirror 2 and the switching mirror 3.

The basic configuration of the optical member 1 has been described above. The optical member 1 can be made thinner, that is, the distance between the pair of mirrors can be made shorter, compared to a configuration (hereinafter referred to as a “comparative example”) in which a pair of mirrors guides the external light L1 and a portion of the incident light L2 by specular reflection.

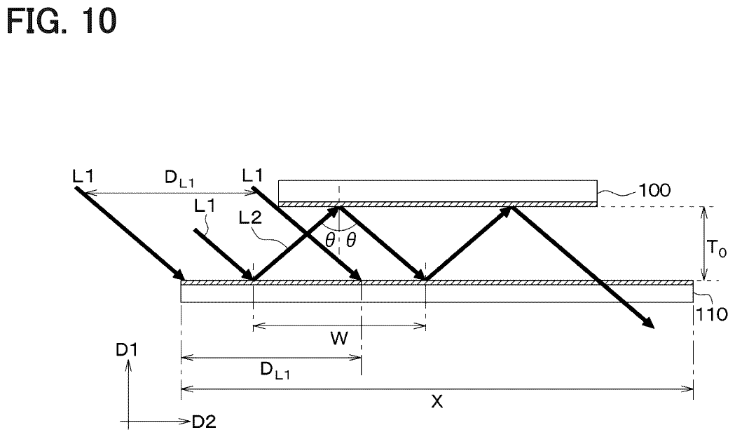

Specifically, the comparative example has a pair of mirrors 100 and 110 as shown in FIG. 10, in which part of the external scene light L1 is specularly reflected by the half mirror 110, and this specularly reflected light is specularly reflected by the mirror 100. In the comparative example, another part of the external light L1 or the specularly reflected light exits to the outside from the half mirror 110. Here, the pair of mirrors 100, 110 are arranged in parallel, the distance between them, that is, the thickness of the optical member of the comparative example, is denoted as T₀, and an incident angle and a reflection angle of light on the pair of mirrors is denoted as θ. In this case, if a width through which the light travels along a plane direction of the mirror 100 when making one round trip between the pair of mirrors 100 and 110 is defined as a round trip width W, W is 2T₀ tan θ.

As shown in FIG. 10, the width of a direct incidence region from one end of the half mirror 110 in the light guiding direction D2 is defined as a direct incidence width D_{L1}, and the width of the half mirror 110 in the same direction is defined as X. The direct incidence width D_{L1} is a width through which the external light L1 can be introduced into the optical member, and affects the average brightness of the light that exits from the half mirror 110. For example, in the comparative example, when the efficiency in reflection and transmission is 100%, the average brightness of the exit light L3 is D_{L1}/X in terms of the actual scene ratio. The actual scene ratio is the ratio of the brightness of a view visually perceived using the exit light L3 to the brightness of a view visually perceived without passing through any optical member. When the direct incidence width D_{L1} coincides with the round trip width W, the comparative example can guide light most efficiently since there is no loss of light, resulting in the above-described average brightness.

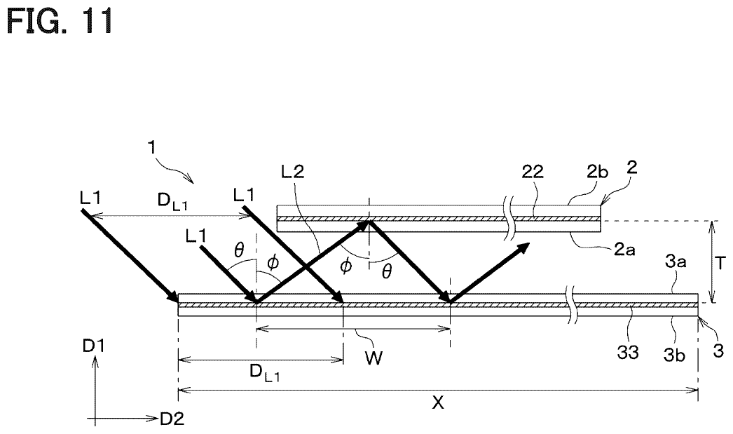

In contrast, the optical member 1 is configured such that light incident on the switching mirror 3 at the incident angle θ is reflected at the reflection angle φ, and light incident on the mirror 2 at the incident angle φ is reflected at the reflection angle θ. Here, for example, as shown in FIG. 11, the distance that the light travels along the light guiding direction D2 when making one round trip between the switching mirror 3 and the mirror 2, that is, the round trip width, is set to W, which is the same as in the comparative example. In this case, the distance in the thickness direction D1 between the first reflective layer 22 of the mirror 2 and the second reflective layer 33 of the switching mirror 3, that is, the thickness, is defined as T. The width of the direct incidence region from the incidence end 3A of the switching mirror 3 is set to D_{L1}, which is the same as in the comparative example, and the width of the switching mirror 3 in the light guiding direction D2 is set to X, which is the same as in the comparative example. In this case, W=T(tan θ+tan φ)=2T₀ tan θ. However, since φ>θ as described above, (tan θ+tan φ)>2 tan θ, and T<T₀ holds. In other words, the optical member 1 is configured to perform asymmetric reflection at the mirror 2 and the switching mirror 3, and thus has a thinner structure than the comparative example in which light is specularly reflected by the pair of mirrors 100 and 110. Furthermore, since the optical member 1 has the same direct incidence width DL1 at the switching mirror 3 as in the comparative example, the average brightness of the exit light L3 is maintained at the same level as or higher than that of the comparative example.

Next, a preferred light adjustment control will be described. The time resolution of human vision is C (unit: Hz), and the time required for switching control to bring each of the first region R1 to the Nth region RN into the transparent state once is referred to as an “entire plane switching time”. At this time, it is preferable that the entire plane switching time of the switching mirror 3 is S (unit: sec) and that S<1/C is satisfied in the light adjustment control.

The time during which each of the regions R1 to RN is in the transparent state due to a single voltage application is referred to as a “transparent time”. The entire plane switching time S refers to a total time of the transparent times for all regions. In other words, it is preferable that the light adjustment control is performed with the entire plane switching time equal to or less than the time resolution of human vision (for example, 1/30 seconds or less). For example, the entire plane switching time S of the switching mirror 3 is preferably 1/30 seconds or less, and more preferably 1/60 seconds or less. As a result, the switching mirror 3 is in a state where the user does not notice the entire switching between the transparent state and the reflective state in the plurality of regions R1 to RN, that is, where the user does not feel uncomfortable due to the light adjustment control. Furthermore, the switching mirror 3 allows the user to visually perceive the outside view by the transmitted light of each of the plurality of regions R1 to RN, that is, the transmitted light from the entire region of the exit surface 3b, by the above-described light adjustment control.

The switching mirror 3 can control the transparent time of each of the plurality of regions R1 to RN individually by changing the time for which a voltage is applied to each of the plurality of regions R1 to RN. For example, if the transparent times of the first region R1, the second region R2, . . . , the Kth region RK, . . . , the (N−1)th region R(N−1), and the Nth region RN are t₁, t₂, . . . , t_{K}, . . . , t_{(N-1)}, and t_{N}, respectively, the entire plane switching time S is expressed by the following mathematical formula (1). Here, K is an integer from 1 to N, and the transparent times t₁ to t_{N} are substantially the same as the energizing times in each region.

$$S = {\sum }_{k = 1}^{N} {t}_{k} \qquad ( 1 )$$

For example, the reflectance of the mirror 2 is R_{f}, the reflectance of the switching mirror 3 in the reflective state is Rₘ, the transmittance of the switching mirror 3 in the transparent state is Tₘ, and the light intensities in the first region R1 to the Nth region RN are I₁ to I_{N}. At this time, the light intensity I₁ of the first region R1, the light intensity I₂ of the second region R₂, and the light intensity I_{N} of the Nth region RN are respectively expressed by the following mathematical formulas (2) to (4).

$${I}_{1} = {T}_{m} \times {t}_{1} / S \qquad ( 2 )$$

$${I}_{2} = {R}_{m} \times {R}_{f} \times {T}_{m} \times {t}_{2} / S \qquad ( 3 )$$

$${I}_{N} = {R}_{m}^{( N - 1 )} \times {R}_{f}^{( N - 1 )} \times {T}_{m} \times {t}_{N} / S \qquad ( 4 )$$

In other words, the lengths of the transparent times t₁ to t_{N} are proportional to the brightness of the view visually perceived by the user in each of the first region R1 to the Nth region RN. In other words, by appropriately changing the transparent times t₁ to t_{N}, it is possible to equalize the light intensities I₁ to I_{N} in the first region R1 to the Nth region RN. For example, in order to make the light intensities of the first region R1 and the second region R2 equal to each other, it is sufficient to satisfy the following mathematical formulas (5) and (6).

$${I}_{2} = I \times {R}_{m} \times {R}_{f} \times {t}_{2} / {t}_{1} \qquad ( 5 )$$

$${t}_{2} = {t}_{1} / ( {R}_{m} \times {R}_{f} ) \qquad ( 6 )$$

A similar relationship holds in the regions after the third region R3. Thus, in order to make the light intensity I₃ in the third region R3 equal to the light intensities in the first region R1 and the second region R2, it is sufficient to satisfy the following mathematical formulas (7) and (8).

$${I}_{3} = {I}_{2} \times {R}_{m} \times {R}_{f} \times {t}_{3} / {t}_{2} = {I}_{1} \times {R}_{m}^{2} \times {R}_{f}^{2} \times {t}_{3} / {t}_{1} \qquad ( 7 )$$

$${t}_{3} = {t}_{1} / ( {R}_{m}^{2} \times {R}_{f}^{2} ) \qquad ( 8 )$$

Similarly, in order to make the light intensity I_{N} in the Nth region RN equal to the light intensity in each of the first region R1 to the (N−1)th region R(N−1), it is sufficient to satisfy the following mathematical formulas (9) and (10).

$${I}_{N} = {I}_{( N - 1 )} \times {R}_{m} \times {R}_{f} \times {t}_{N} / {t}_{( N - 1 )} = {I}_{1} \times {R}_{m}^{( N - 1 )} \times {R}_{f}^{( N - 1 )} \times {t}_{N} / {t}_{1} \qquad ( 9 )$$

$${I}_{N} = {t}_{1} / ( {R}_{m}^{( N - 1 )} \times {R}_{f}^{( N - 1 )} ) \qquad ( 10 )$$

By performing the light adjustment control in the switching mirror 3 to satisfy the mathematical formula (10), the light intensity of the exit light in each of the regions R1 to RN becomes equal, and the brightness of the outside view visually perceived by the user can be made uniform.

According to the present embodiment, the optical member 1 includes the mirror 2 and the switching mirror 3 disposed in parallel, the switching mirror 3 is switchable between the transparent state in which light is transmitted and the reflective state in which light is reflected, and the mirror 2 and the switching mirror 3 are configured to reflect light asymmetrically. In the optical member 1, the switching mirror 3 makes a part of the external light L1 or the incident light L2 having the incident angle θ exit from the exit surface 3b and reflects the other part at the reflection angle φ (>θ), and the mirror 2 reflects the incident light L2 having the incident angle φ at the reflection angle θ. In the optical member 1, the plurality of regions R1 to RN of the switching mirror 3 are switched between the transparent state and the reflective state in a time-division manner, there are no regions on the exit surface 3b from which light does not exit, and no patterned light exits from the exit surface 3b, thereby suppressing a decrease in visibility of the outside view visually perceived by the user. In addition, since the angles of the incident light and the reflected light at the mirror 2 and the switching mirror 3 are different, the optical member 1 is configured such that the distance the light travels when making one round trip between the mirror and the switching mirror is increased compared to when the light is specularly reflected. As a result, the optical member 1 can reduce the distance between the mirror 2 and the switching mirror 3 in accordance with the increase in the distance that the light travels one round trip between the mirror 2 and the switching mirror 3, making it possible to make the optical member 1 thinner. In addition, in the optical member 1, the angle of light transmitted through the switching mirror 3 is the same as the angle of incidence on the switching mirror 3, and the reflected light that is asymmetrically reflected by the switching mirror 3 is returned to the original angle of incidence due to asymmetric reflection by the mirror 2, thereby ensuring continuity between the outside view in the blind spot visually perceived by the user and the outside view that is visually perceived directly by the user.

### Second Embodiment

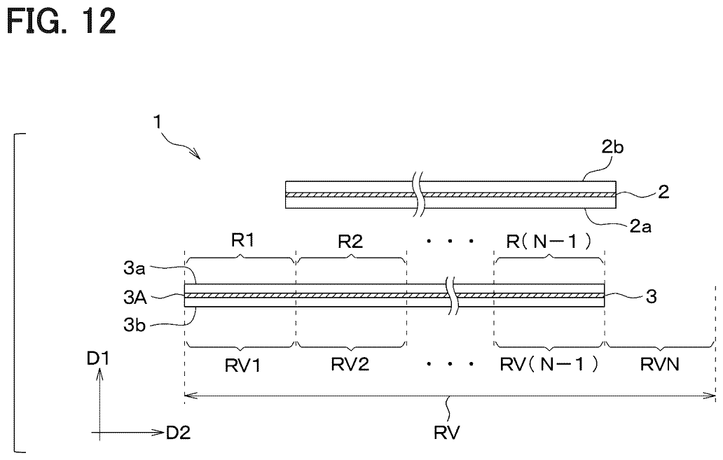

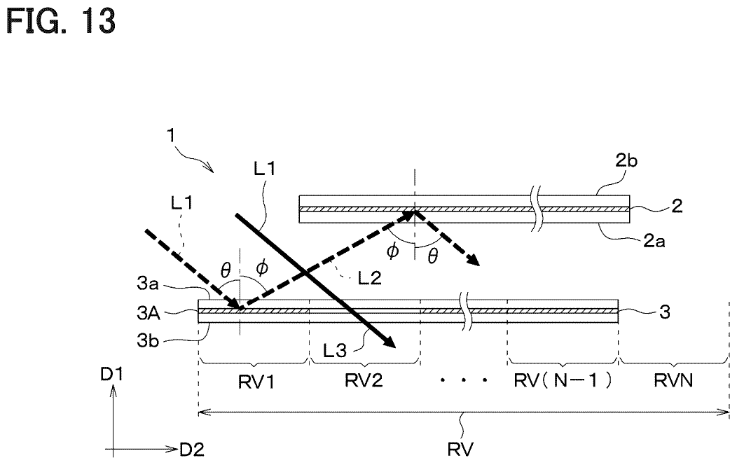

Next, an optical member 1 according to a second embodiment will be described. FIG. 12 and FIG. 13 are cross-sectional views corresponding to FIG. 1.

The optical member 1 of the present embodiment differs from the first embodiment in that, as shown in FIG. 12, the region in which the optical member 1 allows the user to visually perceive the outside view is defined as a visually perceiving region RV, and the switching mirror 3 is not disposed in a region RVN that is located in a terminal end of the visually perceiving region RV. The following describes the difference between the present embodiment and the first embodiment.

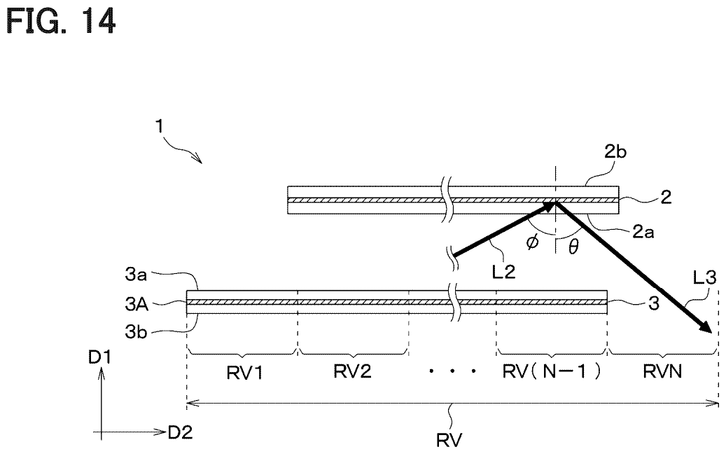

In the present embodiment, as shown in FIG. 12, the switching mirror 3 is disposed so that one end portion in the light guiding direction D2 protrudes from the mirror 2, and the one end portion serves as an incident end portion 3A. For example, when viewed from above, a terminal end portion of the switching mirror 3 opposite the incident end portion 3A is positioned inside the outer contour of the mirror 2, and is not positioned in the region RVN described below which is the farthest from the incident end portion 3A in the visually perceiving region RV. In the present embodiment, the switching mirror 3 is divided into, for example, (N−1) regions R1 to R(N−1), which is one less than the number of regions of the visually perceiving region RV. When the switching mirror 3 makes the exit light L3 exit to a region other than the region RVN in the visually perceiving region RV, as shown in FIG. 13, for example, at least one region among the regions R1 to R(N−1) is controlled to the transparent state. When the switching mirror 3 makes the incident light L2 exit to the terminal region RVN, as shown in FIG. 14, no voltage is applied and the regions R1 to R(N−1) are all in the reflective state. In other words, in the switching mirror 3 according to the present embodiment, the light adjustment control similar to that of the first embodiment is performed for the regions R1 to R(N−1), which are one or more regions less than in the first embodiment, except that no current is applied when the light exits to the terminal region RVN. As a result, the optical member 1 has a structure in which the light adjustment control is simplified and the size thereof is reduced in the light guiding direction D2 compared to the first embodiment.

The visually perceiving region RV is a region where the user visually perceives the outside view by the exit light L3 that exits from the switching mirror 3 or the incident light L2 that is reflected by the mirror 2 and then exits from the optical member 1 without passing through the switching mirror 3. The visually perceiving region RV is divided into N regions RV1 to RVN, for example, from the incident end portion 3A side, such as a first region RV1, a second region RV2, . . . , an (N−1)th region RV(N−1), and an Nth region RVN. The regions RV1 to RVN have, for example, approximately equal widths in the light guiding direction D2, and lights that make different numbers of round trips between the mirror 2 and the switching mirror 3 exit from the respective regions. For ease of explanation, the number of times that light makes round trips between the mirror 2 and the switching mirror 3 will be simply referred to as the “number of round trips”.

For example, in the first region RV1, the external light L1 that reaches the first region R1 of the switching mirror 3 that is in the transparent state, that is, a light that has made zero round trips, exits as the exit light L3, allowing the user to visually perceive the outside view. For example, in the second region RV2, the incident light L2 that reaches the second region R2 of the switching mirror 3 that is in the transparent state, that is, the light that has made one round trip, exits as the exit light L3, allowing the user to visually perceive the outside view. For example, in the (N−1)th region RV(N−1), the incident light L2 that reaches the (N−1)th region R(N−1) of the switching mirror 3 that is in the transparent state, that is, the light that has made (N−2) round trips, exits as the exit light L3, allowing the user to visually perceive the outside view. Then, in the Nth region RVN, as shown in FIG. 14, for example, the incident light L2 that has made (N−1) round trips passes through a region where the switching mirror 3 is not disposed and exits as the exit light L3, allowing the user to visually perceive the outside view.

In the above, a case has been described as a representative example in which the widths of the plurality of regions R1 to R(N−1) of the switching mirror 3 in the light guiding direction coincide with the widths of each region of the visually perceiving region RV and the direct incidence width D_{L1} (=the round trip width W). However, even when the widths are not set as described above, the optical member 1 may be configured such that the switching mirror 3 is not disposed in a region of the visually perceiving region RV to which the light that has made (N−1) round trips exits. For example, even if the optical member 1 has m regions R1 to Rm of the switching mirror 3 within the direct incidence width DL1, as long as the switching mirror 3 is not disposed in the region RVN at the terminal end of the visually perceiving region RV, the effect of simplifying the light adjustment control as described above can be obtained.

According to the present embodiment, in addition to the same effects as those of the first embodiment, the switching mirror 3 is not arranged in the Nth region RVN of the visually perceiving region RV, which is the farthest from the incident end portion 3A, and therefore the optical member 1 has simpler light adjustment control compared to the first embodiment and also has the effect of being more compact.

### Third Embodiment

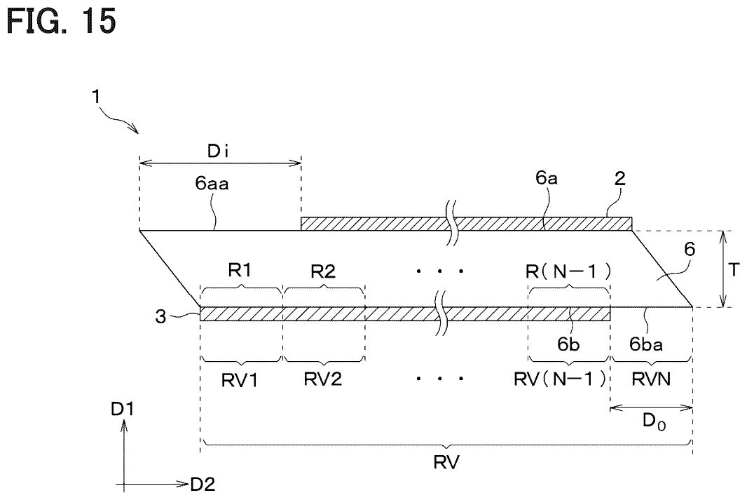

Next, an optical member 1 according to a third embodiment will be described. FIG. 15 shows a cross section corresponding to FIG. 1, and the mirror 2 and the switching mirror 3 are simplified for ease of viewing.

As shown in FIG. 15, for example, the optical member 1 of the present embodiment differs from the first embodiment in that the optical member 1 further includes a light guide body 6 to which the mirror 2 and the switching mirror 3 are attached. The following describes the difference between the present embodiment and the first embodiment.

The light guide body 6 is made of any translucent material, such as a resin material or glass. Examples of the resin material include polyethylene terephthalate, polycarbonate, polyethylene, acrylic, and the like. In the present embodiment, the light guide body 6 is a separate body from the mirror 2 and the switching mirror 3. The mirror 2 and the switching mirror 3 are attached to the light guide body 6 by, for example, an optical adhesive such as optical clear adhesive (not shown). As shown in FIG. 15, for example, the light guide body 6 has a first surface 6a which is a smooth surface, and a second surface 6b which is a smooth surface parallel to the first surface 6a. In the light guide body 6, for example, the mirror 2 is adhered to a part of the first surface 6a and the switching mirror 3 is adhered to a part of the second surface 6b. In the light guide body 6, a predetermined region of the first surface 6a adjacent to one end is exposed from the mirror 2, and this exposed region serves as an incident portion 6aa through which the external light L1 is incident inside. In the light guide body 6, a predetermined region of the second surface 6b adjacent to an end opposite the incident portion 6aa is exposed from the switching mirror 3, and this exposed region serves as an exit portion 6ba from which the incident light L2 exits to the outside without passing through the switching mirror 3. The light guide body 6 only needs to have the first surface 6a and the second surface 6b which are parallel to each other, and the shape of other parts may be appropriately changed within a range that does not interfere with the guiding of the incident light L2 inside the light guide body 6.

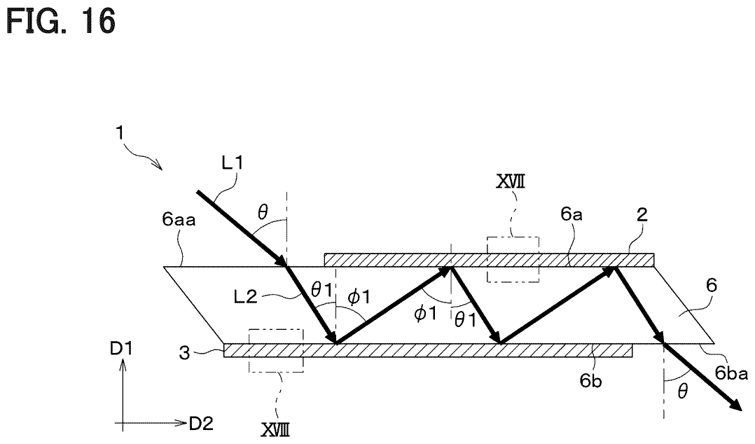

As shown in FIG. 15, when a width of the incident portion 6aa in the light guiding direction D2 is Di and a distance between the first surface 6a and the second surface 6b of the light guide body 6 in the thickness direction D1 is T, Di=T(tan θ1+tan φ1). That is, the width Di of the incident portion 6aa corresponds to the round trip width W in the first and second embodiments. As shown in FIG. 16, θ1 is an incident angle of the incident light L2 on the switching mirror 3, and the incident light L2 is produced when the external light L1 incident on the incident portion 6aa at an incident angle θ is refracted inside the light guide body 6 having a refractive index n. φ1 is a reflection angle of a reflected light that is produced when the incident light L2 having the incident angle θ1 is reflected by the switching mirror 3 in the reflective state, and is larger than θ1. In addition, in the first surface 6a, for example, a region having a width Di from the one end is set as the incident portion 6 aa, and the entire remaining region is covered by the mirror 2.

The exit portion 6ba is a region from which the incident light L2 that has made X round trips between the mirror 2 and the switching mirror 3 exits to the outside without passing through the switching mirror 3. The exit portion 6ba has a width Do in the light guiding direction D2, and Do≤Di.

In addition, the switching mirror 3 is partitioned into a plurality of regions R1 to R(N−1) corresponding to the regions excluding the terminal region RVN among the regions RV1 to RVN that constitute the visually perceiving region RV of the optical member 1, for example, as in the second embodiment described above. Similarly to the second embodiment, the optical member 1 has a configuration in which the switching mirror 3 is not disposed in the Nth region RVN, and the exit portion 6ba of the light guide body 6 corresponds to the Nth region RVN.

In the present embodiment, the mirror 2 and the switching mirror 3 have the same refractive index as the light guide body 6. As a result, in the optical member 1, the incident light L2 that enters the light guide body 6 is not reflected at an interface between the light guide body 6 and the mirror 2 or the switching mirror 3, and noise caused by reflected light at the interface is suppressed.

According to the present embodiment, in addition to the same effects as those of the second embodiment described above, since the mirror 2 and the switching mirror 3 are respectively arranged on the first surface 6a and second surface 6b of the light guide body 6 that are parallel, the optical member 1 can also achieve the effect of stably ensuring the parallel state of the pair of mirrors.

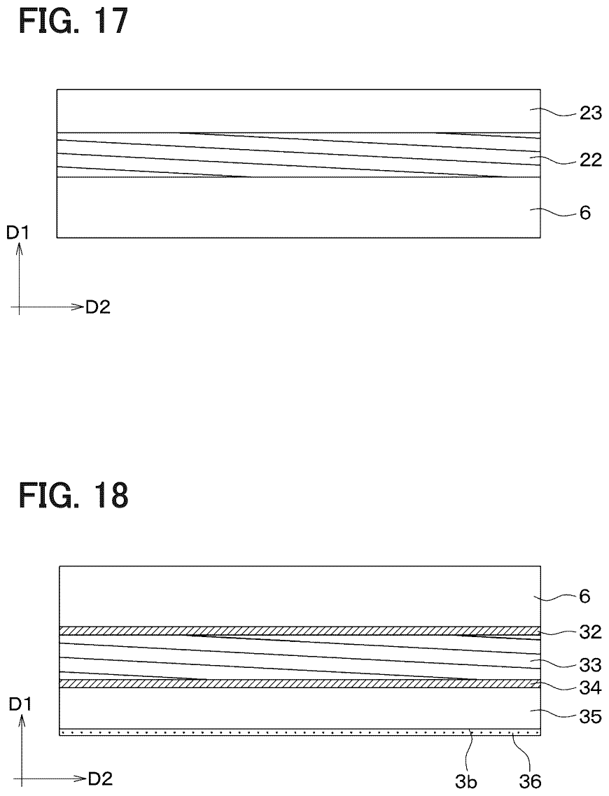

In the above description, the optical member 1 has a structure in which the mirror 2 and the switching mirror 3 are attached to the light guide body 6 with an optical adhesive (not shown), but the present disclosure is not limited to this example. For example, as shown in FIG. 17, the mirror 2 may have a configuration in which the light guide body 6 is used as a support substrate for the first reflective layer 22 instead of the transparent substrate 21, and by including the light guide body 6, the first reflective layer 22 and the light-shielding substrate 23. For example, as shown in FIG. 18, the switching mirror 3 may have a configuration in which the light guide body 6 is used as a support substrate for the second reflective layer 33 instead of the first transparent substrate 31, and the first transparent electrode 32, the second reflective layer 33, the second transparent electrode 34, and the second transparent substrate 35 are laminated on the light guide body 6. In other words, the mirror 2 and the switching mirror 3 may be manufactured separately from the light guide body 6 and attached to the light guide body 6, or may be formed directly on the first surface 6a and the second surface 6b of the light guide body 6. In addition, the optical member 1 may have an anti-reflection layer on the exit portion 6ba in order to prevent external light incident on the second surface 6b from being reflected on the second surface 6b and causing noise. Furthermore, although an example in which the switching mirror 3 is not disposed in the terminal region of the second surface 6b has been described, the present disclosure is not limited to this example, and the optical member 1 may have the switching mirror 3 disposed over the entire region of the second surface 6b.

### Other Embodiments

Although the present disclosure has been made in accordance with the embodiments, it is understood that the present disclosure is not limited to such embodiments and structures. The present disclosure encompasses various modifications and variations within the scope of equivalents. In addition, various combinations and modes, and further, other combinations and modes including one element of these alone, or thereabove, or therebelow, are also comprised within the scope or concept range of the present disclosure.

A controller (for example, the circuit board 5) and the method described in the present disclosure may be implemented by a special purpose computer which is configured with a memory and a processor programmed to execute one or more particular functions embodied in computer programs of the memory. Alternatively, the control unit and the method described in the present disclosure may be implemented by a special purpose computer configured as a processor with one or more special purpose hardware logic circuits. Alternatively, the control unit and the method described in the present disclosure may be implemented by one or more special purpose computers, which are configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Further, in each of the above embodiments, when the shape of an element or the positional relationship between elements is mentioned, the present disclosure is not limited to the specific shape or positional relationship unless otherwise particularly specified or unless the present disclosure is limited to the specific shape or positional relationship in principle.

What is claimed is:

1. An optical member comprising:
a mirror having a first reflective layer that reflects light; and
a switching mirror disposed in parallel with the mirror and having a second reflective layer that is switchable between a transparent state in which light is transmitted and a reflective state in which light is reflected, wherein
a normal direction to a plane of the mirror or a plane of the switching mirror is defined as a thickness direction, an angle between a traveling direction of an incident light that is incident on the mirror or the switching mirror and the thickness direction is defined as an incident angle, and an angle between a traveling direction of a reflected light that is reflected by the mirror or the switching mirror and the thickness direction is defined as a reflection angle,
the first reflective layer has a first inclined plane that is inclined with respect to the plane of the mirror, and an axis along a normal direction to the first inclined plane is a first inclination axis,
the second reflective layer has a second inclined plane that is inclined with respect to the plane of the switching mirror, and an axis along a normal direction to the second inclined plane is a second inclination axis,
the switching mirror is configured to reflect the incident light having the incident angle of θ at the reflection angle of φ that is larger than θ, and
the mirror is configured such that the first inclination axis is parallel to the second inclination axis so as to reflect the incident light having the incident angle of φ at the reflection angle of θ.

2. The optical member according to claim 1, wherein
the second reflective layer is made of a cholesteric liquid crystal.

3. The optical member according to claim 1, wherein
the first reflective layer is made of a cholesteric liquid crystal.

4. The optical member according to claim 2, wherein
the mirror has an anti-reflection layer on a surface facing the switching mirror.

5. The optical member according to claim 3, wherein
the switching mirror has an anti-reflection layer on a facing surface that faces the mirror.

6. The optical member according to claim 1, wherein
the switching mirror is partitioned into a plurality of regions, and
in the second reflective layer, one of the plurality of regions is sequentially switched to the transparent state, and remaining regions of the plurality of regions are brought into the reflective state.

7. The optical member according to claim 1, wherein
a region where light via the switching mirror or the mirror exits and where a user is allowed to visually perceive an outside view is defined as a visually perceiving region,
an end portion of the switching mirror where an external light is incident is defined as an incident end portion,
the visually perceiving region is partitioned into N regions, where N is a natural number greater than or equal to 2, and
the switching mirror is not disposed in an Nth region that is a farthest region in the N regions from the incident end portion.

8. The optical member according to claim 1, further comprising
a light guide body made of a translucent material and having a first surface and a second surface parallel to the first surface, wherein
the mirror is disposed on the first surface, and
the switching mirror is disposed on the second surface.
